(19) United States
(12) Patent Application Publication
(10) Pub. No.: US 2012/0040717 A1
(43) Pub. Date: Feb. 16, 2012

(54) Mobile Data Gathering System and Method

(75) Inventors: Peter Seth Levy, Monte Sereno, CA (US); Michael George Glass, Jacksonville, FL (US); Patrick George Kaldawy, Pleasanton, CA (US)

(73) Assignee: Veechi Corp, Monte Sereno, CA (US)

(21) Appl. No.: 12/857,464

(22) Filed: Aug. 16, 2010

(51) Int. Cl. H04M 1/02; H04N 5/225

(52) U.S. Cl. 455/556.1; 348/222.1; 348/E05.024

(57) ABSTRACT

A system and method are provided for gathering various types of data using a mobile device and organizing such data. Images of text documents can be collected on a mobile device and conveyed to an analysis module for optical character recognition and parsing to categorize and/or classify items of the data. The parsed data items can be entered into a database based on any categories, classifications, identifiers and/or instructions corresponding to the data. Further, image data, text file data, and manually entered data can be conveyed and stored in the database according to categories, classifications, identifiers and/or instructions corresponding to the data to provide for an organized, searchable collection of data.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of data gathering using mobile devices and more particularly to gathering text and image data using handheld mobile devices and techniques such as optical character recognition (OCR) and parsing.

### BACKGROUND

In the age of information, among the most impacting technological progress has been in the field of mobile devices. As access to information and communication channels continues to become faster and more convenient, mobile devices are becoming more and more integral to the way people live their lives and do business. Today, individuals are expected to have full-time access to email, the internet, and various other computerized applications such as notepads, calendars, digital cameras, and so on, on their mobile devices.

However, the ability of a user to gather data in an efficient and organized manner through his or her mobile device remains largely inhibited. For example, a user who wants to record data on his or her mobile device, such as a smart phone, is generally left only with the option of typing the information into a notepad-type application on the mobile device to create a text document. However, typing in data is slow and cumbersome. Further, data that has been typed into a text document is generally unorganized and difficult to search through and work with. It is also possible to enter data via voice transfer, bar code scanning, and other methods, but there are no substantial systems for receiving data in organized fields or structured fields. What is needed is a system and method for gathering data on a mobile device that allows for fast and efficient collection of the data into an organized data bank that can be searched and worked with.

### BRIEF DESCRIPTION OF THE DRAWINGS

FIG. 1 illustrates an example of a data gathering system in accordance with various embodiments.

FIG. 2 illustrates an example of an application that can be used on a smart phone, such as an iPhone, to improve image quality by leveling the iPhone™ and controlling shake, in accordance with various embodiments.

FIG. 3 illustrates an example of an application that can be used on a smart phone, such as an iPhone™ for example, to improve image quality by ensuring that the iPhone is substantially in the same plane as the item being photographed, in accordance with various embodiments.

FIG. 4 illustrates an example process flow for gathering information from an imaged text document, in accordance with various embodiments.

FIG. 5 is a block diagram illustrating an example computing device 500, in accordance with various embodiments.

### DETAILED DESCRIPTION

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning particular mobile devices, networks, interfaces, computing systems, and the like have been omitted inasmuch as such details are not considered necessary to obtain a complete understanding of the present invention and are considered to be within the understanding of persons of ordinary skill in the relevant art. Also, particular devices or software solutions used herein are intended only as examples, and the invention is not limited to any particular example. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the Claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The systems and methods described herein provide an accurate and efficient way to gather, organize, and store data using a mobile device. In various embodiments, the described systems and methods can comprise gathering data using a mobile device, organizing and storing the gathered data in a database, and viewing and analyzing the stored data.

As used herein, the term mobile device can refer to any handheld device that can perform computing functions. Examples of such devices can be smart phones such as the iPhone™, iPad™, or the Droid™

Such mobile devices can contain user interfaces for inputting information such as keyboards, microphones, touchscreen keyboards, touchscreen buttons, photo cameras, video cameras, and so on. Mobile device can contain user interfaces for displaying information such as speakers, screens such as LCD screens that also act as touchscreens, and so on. Mobile devices can contain interfaces for transmitting and receiving data from other devices such as through wireless transmission or through wire transmission on networks such as the internet, telephone lines, and so on.

In various embodiments, one or more mobile devices can be used by one or more respective users to gather data using a variety of methods, which methods will be discussed in further detail below. The gathered data can be analyzed, organized, and categorized in a database or several databases. Such database(s) can be contained remotely, such as on a remote server with which server the mobile device or the mobile device(s) communicate. The mobile device(s) can communicate data to the remote server, where the data can be stored in a database, which database can be accessed by the mobile device(s). Data can also be stored within a database on the mobile device(s). Further, data can be stored on a database in both mobile device(s) and a remote server. In such a case, various techniques can be used to synchronize the data on both the mobile device(s) and the remote database. In various embodiments, data can be stored on the databases within the various mobile devices, various techniques can be used to synchronize the data on the mobile device(s) such that each device has access to information stored in all of the mobile devices cumulatively. Systems and methods for synchronizing data on databases located on various mobile devices, servers, and databases are well known to persons of skills in the art and will not be covered here in detail as such detail is not considered necessary to obtain a complete understanding of the invention.

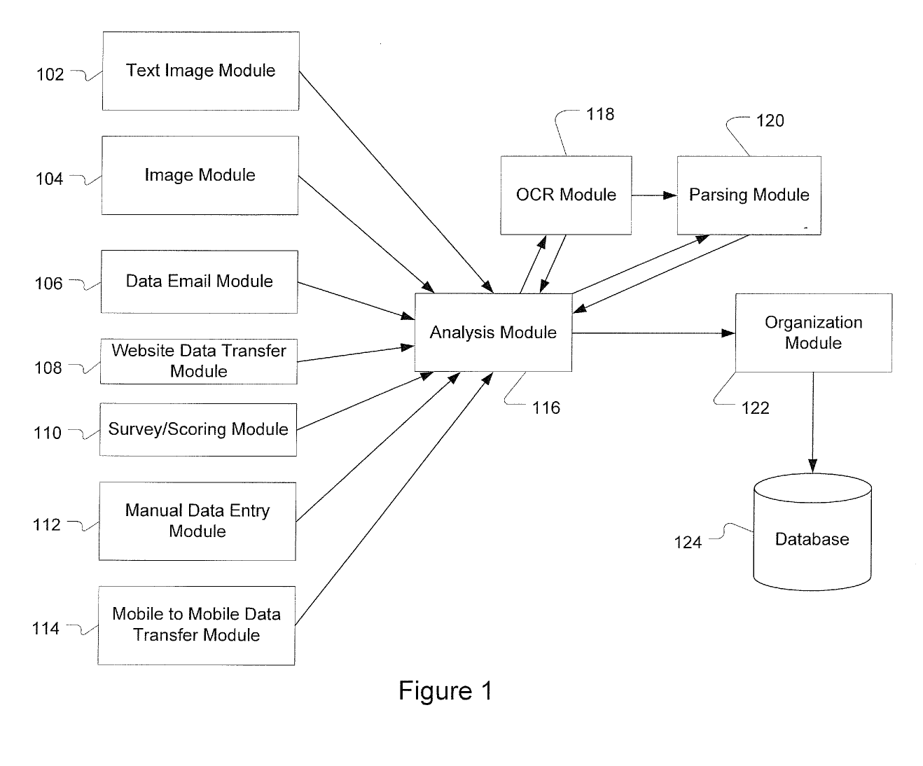

FIG. 1 illustrates an example of a data gathering system in accordance with various embodiments. In the illustrated figures, modules 102-114 can provide various methods for data inputting and collecting of information. Various types of data from the modules 102-114 can be conveyed to an analysis module 116. For example, the data can be in the form of text files such as Microsoft Word files, image files of text documents such as JPEG or PDF files, image files of non-text documents such as JPEG or PDF files, audio files, video files, XML files, and any other type of data file. Further, the data conveyed to the analysis module 116 can contain instructions for what to do with the data and/or any identifying information that can be used to associate the data with any particular category or dimension in a database 124 within the system. In the analysis module 116, data can be processed based on any of: the type of data, the origin of the data, instructions conveyed with the data, identifying information, and so on in order to, for example, categorize/classify the data, process the data, and/or convert the data to a uniform format. The processed data can then be conveyed to an organization module 122, where the data can be used to populate a database 124, fields within an application, fields within a website, and so on.

In various embodiments, text files, such as XML or Microsoft Word documents, can be conveyed to the analysis module 116. Such files can be conveyed to a parsing module 120, in order to parse, in other words categorize, the contents of the file according to contents of the text to extract relevant information. The parsed files can be conveyed to the analysis module 116 for further processing.

In various embodiments, image files of text documents can be conveyed to the analysis module 116. Such files can be conveyed to an optical character recognition (OCR) module 118, where the image files can be converted to a text document, such as an XML or a Microsoft Word document; for example, to allow processing of the document based on its text contents. In an embodiment, the text document can be conveyed back to the analysis module 116 from the OCR module 118. In another embodiment, the text document can be conveyed to the parsing module 120 from the OCR module 118 to produce a parsed file. The parsed files can be conveyed to the analysis module 116 for further processing.

For example, the system can be used in a job candidate recruiting setting. Data such as text documents of a candidate's resume, image files of the candidate's portrait, image files of the candidate's resume, videos of the candidate, audio recordings of an interview, comments about the candidate made by recruiters, data gathered from the internet such as information from social and networking websites, and so on can be conveyed from the modules 102-114 to the analysis module 116. In the analysis module 116, the data can be analyzed to extract information such as candidate name, university, work experience, language skills, and so on from the gathered data. In the organization module 122, the data can be used to create a profile for the particular candidate and to populate fields such as candidate name, university, work experience, language skills, and so on in the profile with corresponding items of the gathered data. Further, the data can be used to populate various categories or fields of the database or corresponding applications/websites, such as by putting comment files into a “comment” field, audio files into an “audio” field, video files into a “video” field, resumes into a “resume” field, and so on. Data can be stored in the database 124. In various embodiments, an application and/or a website can allow the user to access, analyze, and modify the data in the database 124 from a mobile device, a personal computer, or any other device capable of accessing and interfacing with a database. For example, an application on a mobile device or a personal computer can allow the user of the device or computer to access the database to search through and analyze the database by implementing search engines or other computing tools for performing data analysis. A variety of methods for analyzing, displaying, accessing and working with information in databases through mobile devices, personal computers, over internet networks, using applications, and using websites are known to persons of ordinary skill in the art and will not be discussed here in detail as such discussion is not considered necessary for a full understanding of the invention.

In an embodiment, an image file of a text document, such as a JPEG or PDF file of an image of a page of text, can be produced in the text image module 102. As will be explained in greater detail below, a camera, such as a camera integrated into a mobile device, can be used to produce such an image. The image file can be conveyed to the analysis module 116. From the analysis module 116, the image file can be conveyed to an Optical Character Recognition (OCR) module 118. In the OCR module 118, the image file can be converted to a text document. The text document can be conveyed to a parsing module 120, where the text document can be parsed to allow the placing of certain data items in the document into predetermined categories, resulting, for example, in an XML file containing tagged text items. For example, if the document conveyed to parsing module 120 is parsed according to a resume parsing standard, the parsing can produce an XML file or an HR XML (Human Resources XML) file where, for example, the text related to each of: candidate name, address, education, skills, work experience, interests, university, language skills, and so on is uniquely tagged for further categorization and classification. In other embodiments, documents relating to other aspects of the recruiting space, such as transcripts, can be imaged in the text image module 102, converted to text in the OCR module 118, and parsed in the parsing module 120. For example, a transcript can be parsed to isolate data such as GPA, classes taken, year of graduation, disciplinary remarks, and so on. The parsed data can be conveyed to an organization module 122 and a database 124 containing such information can then be populated with the data according to the categorization/classification of each data item. Various methods for performing OCR and parsing will be known to persons of ordinary skill in the art and will not be discussed here in detail as such detail is not considered necessary for a complete understanding of the invention. Solution providers include OCR application vendors such as ABBYY that performs OCR, and has an Apple Corporation's iPhone™ application that performs generic OCR operations, and others include IRIS, NovoDynamics, and Nuance. Resume parsing vendors include Talent Technology (Resume Mirror™), RChilli, and SOVREN. Examples of Apple Corporation's iPhone OCR/parsing apps include Insig Info (CamCard), and ScanBiz Mobile Solutions. In various embodiments, OCR 118 and parsing module 120 can be contained within the mobile device. In other embodiments, OCR module 118 and parsing module 120 can be located on remote servers and be accessed over a network.

For example, in a job candidate recruiting setting. During an interview, a recruiter can take a photograph using a mobile device of a candidate's resume, producing a JPEG file on the recruiter's mobile device. The JPEG file of the resume image can be conveyed to the analysis module 116. The analysis module 116 can recognize the file as a resume image file based on instructions and/or identifying information corresponding to the file. The JPEG file can be conveyed to the OCR module 118 to be converted into a text document. From the OCR module 118, the text document can be conveyed to a parsing module 120, where the text can be parsed according to a HR XML format. The HR XML file can contain information placing candidate data into certain categories, such as education, university, skills, interests, GPA, and other categories applicable in the recruiting field. The HR XML file can be conveyed back to the analysis module 116, where data can be extracted from the HR XML file, formatted, and categorized according to system requirements and configuration. The data can then be conveyed to an organization module 122, which can populate corresponding fields of the database 124 with the data.

In an embodiment, data gathered by performing OCR and parsing on a document can be used to create categories, fields, and/or classifications within the database, in which categories, fields, and/or classifications data relating to the document can be stored. For example, a recruiter using a mobile device can capture a photograph of a job candidate's resume, which candidate's identity is not in the system. The photograph of the resume can be converted to a text document through OCR and parsed. The parsing can identify the name of the candidate. A profile section for the candidate, which section can be identified by the candidate's name, can then be created in the database 124 and in any associated applications/websites. Other data gathered from performing OCR and parsing of the resume can be used to populate fields in the candidate's profile. If the recruiter then gathers other data about the candidate, such as an image, a survey, the recruiter's comments, and so on, that gathered data can be similarly used to populate corresponding fields in the candidate's profile.

For example, a recruiter in the field can collect resumes from potential candidates. The recruiter can take a picture of each resume as it is given to the recruiter by a candidate. If the candidate already has a profile stored in the system, then the resume can be processed with OCR, parsed, and the extracted data can be used to populate corresponding fields of the candidate's profile. If the candidate does not have a profile stored in the system, then the resume can be processed with OCR, parsed, and the extracted data can be used to create a profile section for the candidate in the system; the parsed data can then be used to populate corresponding fields of the candidate's profile.

Alternatively, a recruiter can collect resumes from candidates for later processing. In this case, the recruiter can take a stack of collected resumes and capture an image of each resume on the recruiter's mobile device at the later time. An image of each candidate's resume can be conveyed through the system. If the candidate already has a profile stored in the system, then the resume can be processed with OCR, parsed, and the extracted data can be used to populate corresponding fields of the candidate's profile. If the candidate does not have a profile stored in the system, then the resume can be processed with OCR, parsed, and the extracted data can be used to create a profile section for the candidate in the system; the parsed data can then be used to populate corresponding fields of the candidate's profile.

In an embodiment, an image file of a subject, such as a JPEG or PDF file photograph, can be produced in the image module 104. A camera, such as a camera integrated into the mobile device, can be used to produce such an image file. The image file, along with instructions/identifiers to classify or characterize the image file, can be conveyed to the analysis module 116, where the data can be associated with any particular category or dimension of information according to the instructions/identifiers provided with the image file. For example, in the job candidate recruiting setting, a photograph of a job candidate can be conveyed to the analysis module 116 along with instructions and/or identifier information identifying that the file is a portrait of a candidate and identifying the particular candidate such that the photograph can be associated with the portrait section of the particular candidate's profile in the database and in any associated applications. The file can be conveyed to the organization module 122 and a database 124 can be populated with the photograph to, for example, update the candidate's profile with the photograph. Photographs of other objects pertinent to the candidate, such as photos of a science project, a sculpture, and so on can be similarly produced and stored in relevant field within applications, websites, and databases in the system.

In an embodiment, a data email module 106 can be used to gather data. The data email module 106 can produce a unique identifier, such that, if an email containing the unique identified in a predetermined location of the email, such as in the subject line or in the body of the email, is sent to a specific email address, the contents of that email will be associated with a particular category or classification in the system corresponding to the unique identifier. For example, the email address can be the address of a server containing the analysis module 116. The contents of an email sent to the server containing a specific identifier in the subject line can be conveyed to the analysis module and analyzed according to a predetermined sequence, which sequence can be based on the unique identifier. For example, in the recruiting setting, the data email module 106 can send an email from a server containing the analysis module 116 to a job candidate; for example, the email can be seeking the candidate's resume.

In another embodiment, a unique identifier may be the email address of the candidate. For example, if a request is made to sampole@sample.com, and a resume is received from the same address, no other identifier is consulted. But if a resume is received from an email address that does not match any email address that requests were sent to, then the unique identifier is used to identify the candidate. This is useful because it allows a candidate to send in a resume and not have to have any unique identifier in the subject line. The reason this may be important is that many phones (like the iPhone for example), cannot respond to an email and add an attachment. You have to create a new e-mail with an attachment. In that case, the iPhone user would have to create a new email, copy and paste the unique identifier, and then attach the resume and send. So by using the email as the unique identifier, the copy/paste step is eliminated.

The email can contain a unique identifier in the subject line. When the potential candidate replies with his or her resume, the reply email can be sent to the server with the unique identifier in the subject line. The email can be received at the server and conveyed to the analysis module. Based on the unique identifier, the analysis module 116 can identify the identity of the candidate whom the email pertains to and convey the resume file to the organization module 122 with information regarding the identity of the candidate to whom the resume pertains so that the resume can be populated into the proper location in the database 124. Furthermore, if the candidate submits a resume in PDF or JPEG format, the analysis module can convey the resume to the OCR 118 and parsing 120 modules to extract parsed data as described above before conveying data to the organization module 122. In another embodiment, if the candidate submits a resume in text document format, the analysis module can convey the resume to the parsing module 120 to extract categorized data as described above before conveying the data to the organization module 122.

In an embodiment, a website data transfer module 108 can be implemented to gather data from internet websites. For example, a user of the system may desire to associate certain data contained on the website on a server that is part of the system, such as a server containing the analysis module 116, with a particular category of data in the system. The user can make such an association through the website data transfer module 108. For example, in the recruitment setting, a user may be interviewing a candidate, which candidate may already have a resume uploaded on a private, password protected, portion of a website, which website can be part of the system and located on the server 116. The user can enter the candidate's identity and password into the website data transfer module 108 to have the resume that the user stored on the website transferred to or become available in the profile section of the particular candidate. In another embodiment, the website data transfer module 108 can gather data to be inputted into the system from independent sources on the internet. For example, in the recruiting setting, the website data transfer module 108 can gather data about a candidate from publicly available sources of profile information such as FaceBook™, Plaxo™, and Linkedin™, and other networking and social websites. The data gathered from such websites can be populated into corresponding fields of a website and categories in a database 124. For example, data corresponding to what organizations a candidate is a member of, what online community the member frequents, what networks the member belongs to, and so on can be gathered from websites such as FaceBook™, Plaxo™, and Linkedin™ and such information can be populated into sections of the candidate's profile corresponding to networks, communities, and so forth on the database 124.

In an embodiment, a survey/scoring module 110 can be implemented to allow a user of the system to input data. Such a survey/scoring module 110 can present the user with a survey, list of options, and/or a scoring system that allows the user to provide input by, for example, answering questions and assigning ratings instead of writing comments. The user's inputs to the survey/scoring module 110 can be made to correspond to a specific category of data or to a specific subject in various ways, for example, by having the user directly select a category of data or subject. For example, in the recruiting setting, a recruiter using the system can rate a job candidate on several dimensions, such as communication skills, presentation, enthusiasm, etc. The ratings can be made to correspond to the job candidate's profile, for example, by having the user enter the survey through a link in the user's profile or by having the user directly associate the rating with the particular candidate's identity.

In an embodiment, a manual data entry module 112 can be implemented to allow the user to manually enter data into the system. The user's inputs to the manual data entry module 112 can be made to correspond to a specific category of data or subject in various ways, for example, by having the user select a category of data or a subject. For example, the manual data entry module can allow the user to type comments into a selected category or field of data through the user's mobile device. Alternatively, the user can input an audio file into the manual data entry module 112, such as a voice recording of his or her voice comments. Such a voice recording can be made using a microphone, such as a microphone integral to the mobile device. In an embodiment, the system can incorporate systems that can transcribe the voice files into text. For example, in the recruiting setting, the recruiter can type into her mobile device comments about a candidate whom the recruiter has interviewed. Such comments can be entered into the candidate's profile on the database 124. Alternatively, the recruiter can input comments by recording an audio file into the manual data entry module 112, such as by speaking into a microphone connected to a recording application on the recruiter's mobile device. In an embodiment, the system can incorporate systems that can transcribe the voice files into text. The comment files can be conveyed to the analysis module 116 and to the organization module 122 and stored in corresponding sections of the user's profile in the database 124.

In another embodiment, a mobile to mobile data transfer module 114 can allow the direct transfer of a data file from one mobile device to another. Namely, numerous technologies are available for providing direct wireless transfer between mobile devices that are in close proximity, such as the “Bump” application available for iPhone™ smart phones, which allows transfer of data between two iPhones™ when the phones are bumped together. Such technology can be implemented to provide for transfer of data to the system through the mobile to mobile data transfer module 114 when a system user connects his or her mobile device to a mobile device containing desired information. For example, in the recruiting setting, a recruiter using the system can transfer data, such as a resume, from a candidate's mobile device into the system through the mobile to mobile data transfer module 114 by bumping the recruiter's iPhone and the candidate's iPhone™, implementing an application such as the “Bump” application of the iPhone.

In an embodiment, various types of filters can be implemented to control what data is stored or is accessible by users of the system. Access to certain data can be limited to specific users, such access restrictions can be enforced by identifying users through a log-in procedure and limiting user access based on user identity. For example, certain types of data can be deleted by the system to help meet government compliance mandates, such as the Equal Employment Opportunity Commission (EEOC) compliance mandate for employers and Title VII of the Civil Rights Act and Executive Order 11246 that establish “protected classes” that employers cannot discriminate against. Hence, in various embodiments, data that relates to information that could cause a recruiter to violate compliance mandates, or have exposure to information that could be perceived to bias a recruiter in violation of compliance mandates, can be automatically deleted. Such data can be information disclosing that a person is of a certain race, ethnicity, affiliation, etc. Data to be deleted can be identified by the system in various ways; for example, the system can be configured to delete all data that is placed in a certain category during parsing, such as race, ethnicity, gender, etc. Further, the system can be configured to delete certain terms, for example, any terms identifying a nationality can be deleted by the system. In various embodiments, the system can be configured to disallow the taking of a photo of a candidate's portrait, if that would reveal too much information about the candidate's protected qualities. Data relating to affiliation with certain groups could similarly be blocked, such as membership in an organization such as the NAACP.

Furthermore, compliance mandates, such as the Office of Federal Contract Compliance Programs (OFCCP) requires that employers keep records of activities in recruiting a candidate, including source documents viewed while assessing candidates, and have those records available for either one or two years, depending on the situation. In various embodiments, the system can be configured to allow recording and storing of such information for specified periods of time to assist in legal compliance.

In various embodiments, the connections between the various modules and the database 124 illustrated in FIG. 1 can be either direct, through a network, or through a series of networks. For example, the modules for inputting information 102-114 can be contained within a mobile device that communicates the information between the modules 102-114 and the analysis module 116 over any communication network, or series of networks, available to the mobile device, such as the internet, telephone lines, cabling, wireless data transfer, etc. The analysis module 116 and the organization module 122 can be located on a remote server(s). The database 124 can be accessible by the mobile device for searching and analyzing information through servers. The OCR module 118 can similarly be located on a separate server, such as if the OCR module 118 is an application available from a third party vendor. Similarly, the parsing module 120 can be located on a separate server, such as if the parsing module 120 is an application available from a third party vendor. In various embodiments, communication with servers can be over standard internet connections. Where applicable, communication between any components in the system can be over any medium, communication network, or series of networks, available to the components, such as the internet, telephone lines, cabling, fiber optics, wireless data transfer, etc. Where applicable, data can be transmitted between components of the system in any available form, such as through email, SMS messages, any internet data transfer, telephone calls, data packets, streams, etc.

In another embodiment, the modules and database 124 illustrated in FIG. 1 can be located within a unitized mobile device. For example, the modules and database illustrated in FIG. 1 can be located within a single mobile device, such as a smart phone.

In various embodiments, numerous mobile devices can be implemented in a single system. For example, numerous mobile devices can be used to input, analyze, view, and process data that is located on a single database. Similarly, numerous mobile devices can communicate with one or more servers that perform the various functions of this invention. In other embodiments, numerous mobile devices can store data on databases within the mobile devices and the mobile devices can be configured to allow access of a database on one mobile device by another mobile device.

In an embodiment, the invention can be configured to allow data gathering through a series of incremental assessments. For instance, in the recruiting area, as soon as a resume is parsed it can be assessed or “scored” against certain criteria (e.g. GPA, language fluency, years of experience, etc). Such an assessment can include other items that are determined instantly, such as an analysis of the candidate's social footprint gathered from websites such as Facebook, Plaxo, and Linkedin as described above, school transcript, etc. A low scoring candidate might not be permitted to proceed from this phase. A high scoring candidate who does proceed can, for example, complete a questionnaire on a mobile device, which might include questions about job preferences, salary requirements, etc. Again, candidates who do not pass this assessment may be prevented from moving onto the next stage. Finally, the candidates who proceed may get an interview with the on-site recruiter. In various embodiments, the particular ways of assessing the candidates at each stage, the rules for passing each stage, and the number of stages can vary according to user preferences. This way, the most suitable candidates can get the most time, and the least suitable candidates can be flushed out of the system quickly to avoid wasting of resources.

In various embodiments, data can be gathered through a mobile device by photographing a text document using a camera application on the mobile device and conveying the image of the text document to OCR and parsing modules where the image of the text document can be converted to a text rendering and parsed, as described above. In such applications, the quality of the image can be an important factor for performing successful OCR. Image quality can be impaired if the camera is not in the same plane as the page being photographed, which can result in one side of the page being closer to the camera than another side and corresponding distortion and miss-focusing of text. Further, image quality can be impaired if the camera shakes during the photograph capture, resulting in blurred images.

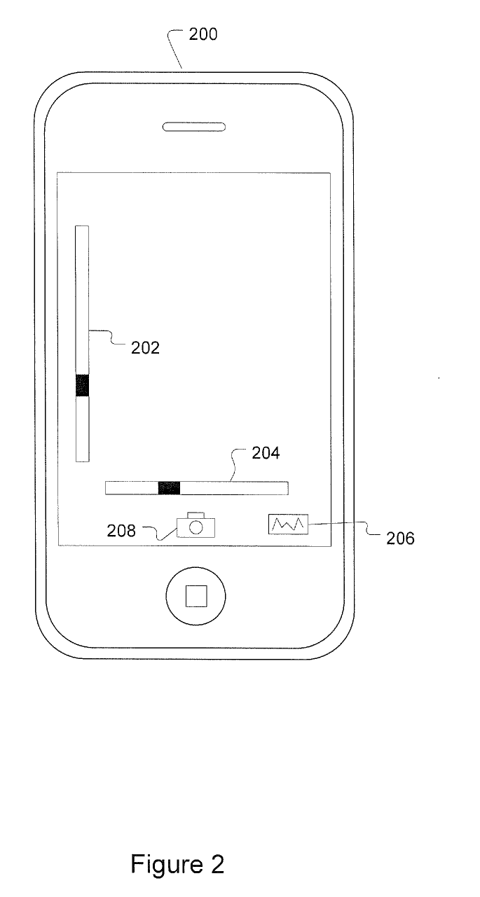

FIG. 2 illustrates an example of an application that can be used on a smart phone, such as an iPhone, to improve image quality by leveling the iPhone and controlling shake, in accordance with various embodiments. As illustrated in the figure, an iPhone 200 can be used to take a photograph of a text document. Although the example in the illustration depicts an iPhone, it will be evident to one skilled in the art that the invention can be implemented in a variety of mobile devices containing a camera and other necessary features. The text document can be placed on a level surface and the smart phone can be positioned above the document at a distance such that the text document takes up the majority of the camera's coverage area. An accelerometer or another device in the smart phone capable of measuring the orientation of the device in relation to the earth can be used to adjust the orientation of the mobile device such that the mobile device and the camera are substantially level with the earth, and hence with the page being photographed. The accelerometer can indicate to the user when the mobile device is level through various means, such as through a visual display. In the example illustrated, a virtual level oriented in the vertical direction 202 and a virtual level oriented in the horizontal direction 204, simulating a carpenter's level, can be displayed on the screen of the device 200. The black dots in the virtual levels 202, 204 can simulate the bubble in a carpenter level, such that when both dots are in the middle of the respective level, the device is in a level plane with the earth. Leveling the device with a two-dimensional level, such as illustrated in the example of FIG. 2, allows the user to place the device in a level plane. Further, a shock indicator 206 can be provided to indicate to the user when the device 200 is experiencing too much movement to produce a quality image. For instance, when the device 200 is moving too rapidly to produce a quality image, the indicator 206 can be red, and when the device is sufficiently steady, the indicator 206 can be green. An accelerometer or other type of motion or orientation detector in the device can be implemented to measure the motion of the device 200; the indicator 206 can operate by indicating that the device is sufficiently steady when the amount of motion measured by the motion detector is below a predetermined threshold and by indicating that the device is not sufficiently steady when the amount of motion measured by the motion detector is above a predetermined threshold. A button 208 can be provided in the application that can trigger the camera when pressed by the user, such a button can be a virtual button on a touchscreen. In an embodiment, after the user presses/touches the button, the application can wait until the camera is level and/or steady before taking the photograph. In various embodiments, other visual or audio elements than simulated bubble levels and bi-color shock indicators can be used to communicate level of the device and movement to the user. For example, degree measurements; a virtual ball on a circular plate, where the ball rolls to the center of the plate when the device is level; or other representations of the level of the device can be implemented without straying from the scope of the invention.

Further, an automatic image orientation function can be implemented to ensure that the photograph is oriented in the correct direction, such that text is in horizontal lines reading left to right, regardless of how the mobile device is held when the photo is captured. For example, an orientation detecting device, such as an accelerometer, can be used to measure the orientation of the mobile device with respect to the earth. Once the photograph is captured, the resulting image can be rotated to counteract the measured orientation of the mobile device. For example, if the mobile device is held at an angle of 90 degrees clockwise of normal when an image is captured, the resulting image can be rotated 90 degrees clockwise to correct orientation. In another embodiment, automatic image analysis techniques can be used to estimate the angle of the text in an image and the image can be rotated such that the text is horizontal.

Further, in various embodiments, a synchronized flash can be implemented in the photographing device to ensure that there is sufficient light to produce a quality image.

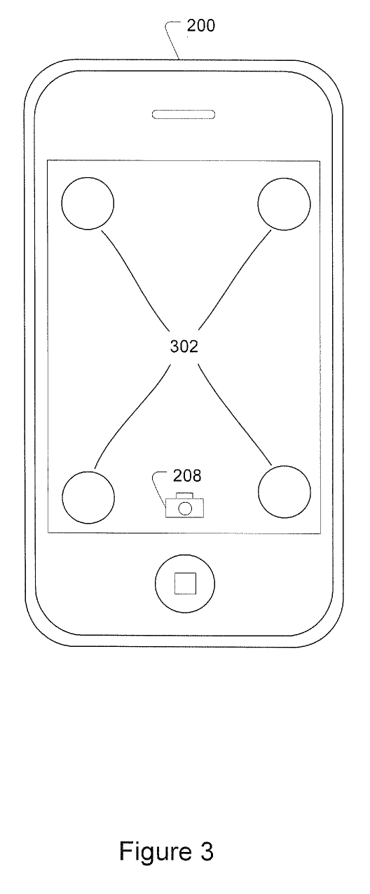

FIG. 3 illustrates an example of an application that can be used on a smart phone, such as an iPhone, to improve image quality by ensuring that the iPhone is substantially in the same plane as the item being photographed, in accordance with various embodiments. As illustrated in the figure, an iPhone 200 can be used to take a photograph of a text document. Although the example in the illustration depicts an iPhone, it will be evident to one skilled in the art that the invention can be implemented in a variety of mobile devices containing a camera and other necessary features. The text document can be held still and the iPhone can be positioned above the document at a distance such that the text document takes up the majority of the camera's coverage area. Four focus areas 302 on the live digital image can be analyzed by the application to determine focus in those areas. When all four areas are in focus, the photograph can be taken. For example, the user can press/touch a button 208 on the screen to take the photograph. In an embodiment, after the user presses the button, the device will wait until all four areas are in focus before capturing the photograph, allowing the user to adjust orientation until all areas are in focus. The application can indicate to the user when each of the four focus areas 302 are in focus by, for example showing a green circle in the area when the area is in focus and showing a red circle in the area when the area is out of focus, along with the words “up” or “down” in the corresponding circle, indicating that, that particular corner of the device should be adjusted up or down, respectively, to optimize focus.

In various embodiments, focus in each of the four corner focus areas 302 can be based on the properties of printed words and resumes. For example, a resume will generally contain dark letters on a light background. Hence, a properly focused image will exhibit a rapid transition from dark to light on the edge of each character. Out of focus, or blurry, text will have a gradual transition from dark to light on the edge of each character. Thus, in various embodiments, such a “color transition” analysis can be performed by the system to adjust or measure focus.

Numerous techniques are available and well known in the art for determining focus from a live digital image and will not be covered here in detail as such detail is not necessary for a complete understanding of the invention. In various embodiments, the application can further incorporate a shock sensing feature as illustrated in the example of FIG. 2. Further, an automatic image orientation function, as described above in the example of FIG. 2, can be implemented to ensure that the photograph is oriented in the correct direction, such that text is in horizontal lines reading left to right, regardless of how the mobile device is held when the photo is captured.

Further, in various embodiments, a synchronized flash can be implemented in the photographing device to ensure that there is sufficient light to produce a quality image.

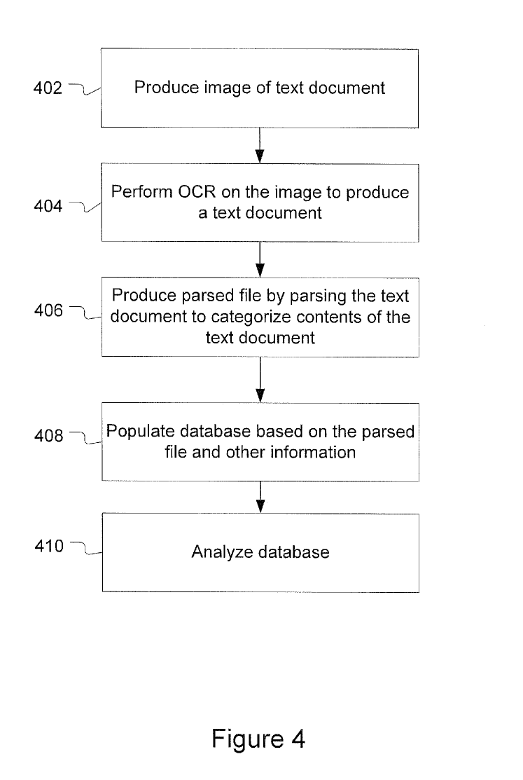

FIG. 4 illustrates an example process flow for gathering information from an imaged text document, in accordance with various embodiments. An image file of a text document, such as a JPEG or PDF file of an image of a page of text, can be produced 402. A camera, such as a camera integrated into a mobile device, can be used to produce such an image. A text rendering of the image can be performed through Optical Character Recognition (OCR) to produce a text document 404. The parsing can result in a file, such as an XML file, that places contents of the text file into various categories. The parsed file as well as other instructions and identifying information can be used to populate and update relevant fields in a database 408. For example, fields in the database can be populated by text from corresponding categories identified in the parsed file. The database can be analyzed 410 based on the data in the various categories. The analysis can be performed from a mobile device or a personal computer by accessing the database either directly or through a network.

In various embodiments, information can be gathered on multiple mobile devices and stored in one or more databases, such databases can be located on the mobile devices or on one or more servers accessible by the mobile devices through a network. In various embodiments, the system can be configured such that information in various databases within the system is synchronized. For example, data gathered through each mobile device can be used to update a central database and the database in each mobile device can be periodically or continuously synchronized with the central database such that each device contains all relevant information in the system. Alternatively, mobile devices can be configured to periodically or continuously communicate with each other to synchronize databases such that each device contains all relevant information. Alternatively, all information can be stored on a central database and each mobile device can be configured to have access to the information on the central database without having a synchronized database within the mobile device. For example, in the recruiting setting, multiple recruiters can be recruiting with multiple mobile devices. By synchronizing the databases within the system, as described above; each recruiter, through her mobile device, can have access to candidate information gathered by all of the recruiters.

In various embodiments, the system can be configured such that if a user gathering information through his or her mobile device does not have access to a communication network, the data can be stored on the mobile device and communicated through the system once a communication network becomes available. For example, a recruiter might not have access to a communication network during a job fair. All information can be stored on the recruiter's mobile device as the information is gathered on the mobile device by the recruiter. Once a communication network becomes available, the gathered data can be communicated through the system for processing and any relevant fields within applications, websites, and database(s) can be populated with the gathered and processed data by the system.

In various embodiments, the described systems and methods can be implemented in any applicable area or business. For example, the described systems and methods can be implemented in various medical fields to obtain, organize, store, analyze, and display data relating to patient health records. For example, images of patients, doctor notes, diagnosis, and so on can be collected through mobile devices, analyzed, and stored using the described systems and methods to produce an organized database of patient information. In other areas, such as record keeping for documents and books within an organization, record keeping in a scientific study, etc., the described systems and methods can be similarly implemented.

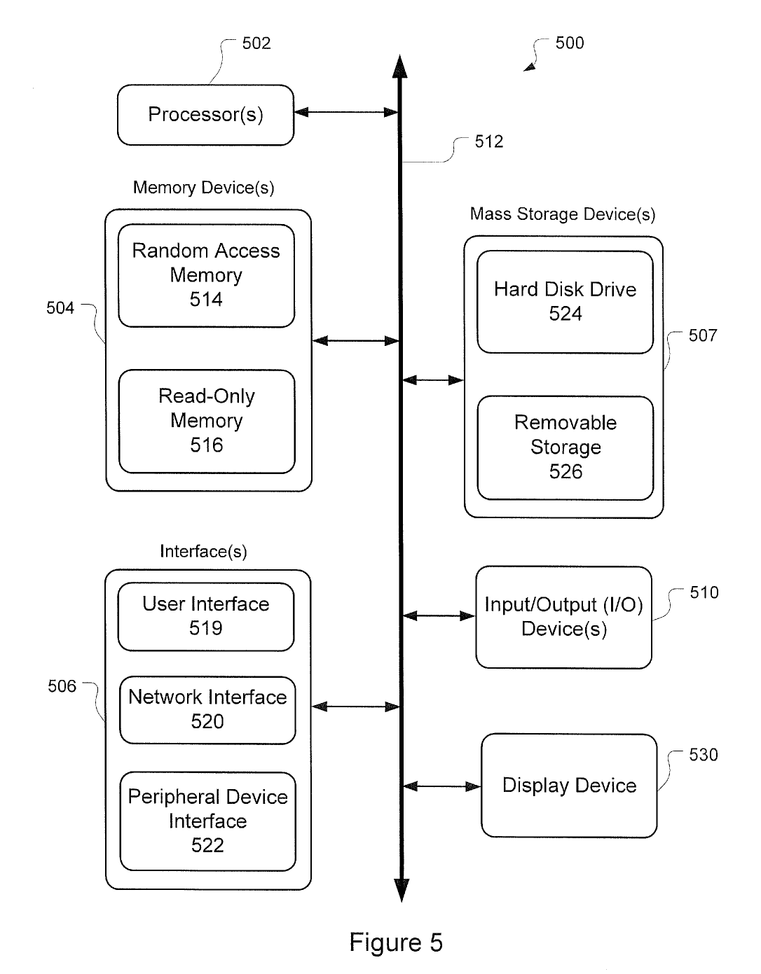

FIG. 5 is a block diagram illustrating an example computing device 500, in accordance with various embodiments. Computing device 500 may be used to perform various procedures, such as those discussed herein. Computing device 500 can function as a server, a mobile device, or any other computing entity. Computing device 500 can be any of a wide variety of computing devices, such as a desktop computer, a notebook computer, a server computer, a handheld computer, and the like.

Computing device 500 includes one or more processor(s) 502, one or more memory device(s) 504, one or more interface(s) 506, one or more mass storage device(s) 507, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 507. Processor(s) 502 may also include various types of computer-readable media, such as cache memory.

Memory device(s) 504 include various computer-readable media, such as volatile memory (e.g., random access memory (RAM)) 514 and/or nonvolatile memory (e.g., read-only memory (ROM) 516). Memory device(s) 504 may also include rewritable ROM, such as Flash memory.

Mass storage device(s) 507 include various computer readable media, such as magnetic tapes, magnetic disks, optical disks, solid state memory (e.g., Flash memory), and so forth. One type of mass storage device is a hard disk drive 524. Various drives may also be included in mass storage device(s) 507 to enable reading from and/or writing to the various computer readable media. Mass storage device(s) 507 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 include any number of different network interfaces 520, such as interfaces to local area networks (LANs), wide area networks (WANs), wireless networks, and the Internet. Other interfaces include user interface 519 and peripheral device interface 522.

Bus 512 allows processor(s) 502, memory device(s) 504, interface(s) 506, mass storage device(s) 507, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate gathering and organizing data using mobile devices. Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A system for capturing data, comprising:
a handheld device having a two-dimensional level configured to set the level of a plane and a camera configured to capture an image on a parallel plane;
an analysis module configured to convert an image to a text rendering using optical character recognition and to parse out text data into separate categories;
an organization module configured to place categories of text data and other content into different application fields, the organization module including a search engine configured to search text data in the different application fields; and
a display configured to display data and content placed by the organization module.

2. A system according to claim 1, wherein the handheld device is a smart phone having a two-dimensional level application for leveling a plane of the smart phone.

3. A system according to claim 1, wherein the handheld device is a smart phone having an accelerometer configured to communicate with a two-dimensional level application for leveling a plane of the smart phone.

4. A system according to claim 1, wherein the system is configured in a unitized housing having a processor, digital data storage, and the display.

5. A device for capturing data, comprising:
a two-dimensional level configured to set the level of a plane;
a camera configured to capture an image on a parallel plane;
an analysis module configured to convert an image to a text rendering using optical character recognition and to parse out text data into separate categories;
an organization module configured to place categories of text data and other content into different application fields, the organization module including a search engine configured to search text data in the different application fields; and
a display configured to display data and content placed by the organization module.

6. A device according to claim 5, wherein the device is a smart phone having a two-dimensional level application for leveling a plane of the smart phone.

7. A device according to claim 5, wherein the device is a smart phone having an accelerometer configured to communicate with a two-dimensional level application for leveling a plane of the smart phone.

8. A device according to claim 5, wherein the device is configured in a unitized housing having a processor, digital data storage, and the display.

9. In a system having a handheld device with a digital processor, a camera, a display screen, and a communication module, a method for capturing data, comprising:
setting the level of a plane;
capturing an image on a parallel plane;
converting an image to a text rendering using optical character recognition;
parsing out text data into separate categories;
placing categories of text data and other content into different application fields;
searching text data in the different application fields; and
displaying data and content placed by the organization module.

10. A system according to claim 9, wherein the handheld device is a smart phone having a two-dimensional level application for setting the level of a plane.

11. A system according to claim 9, wherein the handheld device is a smart phone having an accelerometer configured to communicate with a two-dimensional level application for setting the level of a plane.

12. A system according to claim 9, wherein the handheld device is configured in a unitized housing having a processor, digital data storage, and the display.
